(19) United States
(12) Patent Application Publication
(10) Pub. No.: US 2008/0155791 A1
(43) Pub. Date: Jul. 3, 2008

(54) Knotless cord

(76) Inventors: Hirokazu Matsui, Tsukuba-shi (JP); Masaru Satou, Omitama-shi (JP); Satoshi Hashimoto, Omitama-shi (JP); Toru Nakamura, Tokyo (JP)

Correspondence Address: REED SMITH LLP, Suite 1400, 3110 Fairview Park Drive, Falls Church, VA, 22042, US

(21) Appl. No.: 11/987,331

(22) Filed: Nov. 29, 2007

(30) Foreign Application Priority Data
Nov. 29, 2006 (JP) P2006-322305

(51) Int. Cl. F16G 11/00; D07B 7/00

(52) U.S. Cl. 24/115 R; 57/200

(57) ABSTRACT

To provide a knotless cord that is capable of exerting sufficient tensile strength of a fibrous body. A knotless cord has a sleeve and a fibrous body inserted into the sleeve, wherein the sleeve and the fibrous body are connected to each other by applying tension in a longitudinal direction of the sleeve and then tightening the sleeve. Moreover, in the knotless cord a locking portion for preventing the fibrous body from slipping out of the sleeve is provided in at least two sections (first locking portion, second locking portion). Therefore, stress generated by applying tension is dispersed throughout the entire fibrous body, while preventing the fibrous body from slipping out of the sleeve, whereby stress concentration occurring in each locking portion is alleviated.

### BACKGROUND OF THE INVENTION

1. Field of the Invention

The present invention relates to a knotless cord for connecting a sleeve and a fibrous body to each other without forming a knot to connect them.

2. Description of the Related Art

There has conventionally been known the connecting means for connecting fibrous bodies to each other. However, when using this means, joining or the like needs to be performed according to the type of each fibrous body to be connected, thus the work of connecting the fibrous bodies to each other might become complicated. Moreover, the problem of the connecting means is low knot strength, and such a problem is notable especially when fibrous fibers are thick.

Therefore, there is proposed a knotless cord in which a fibrous body is inserted into a sleeve and the sleeve and the fibrous body are connected to each other by applying tension to a length direction of the sleeve and then tightening the sleeve, (see, for example, Japanese Unexamined Utility Model Application Publication No. H6-45461).

### SUMMARY OF THE INVENTION

However, the knotless cord described above has the following problems. Specifically, when, for example, relatively large tension is applied to the knotless cord, the connecting strength between the sleeve and fibrous fiber is insufficient that the fibrous body sometimes slips out of the sleeve. On the other hand, when, for example, the both fibrous body and the sleeve are adhered to each other tightly so that they do not slip out of each other, stress generated by applying tension is concentrated at the adhered section (stress concentration), whereby the fibrous body is ruptured at this section. Therefore, there is a problem that the primary tensile strength of the fibrous body cannot be exerted sufficiently.

It is therefore an object of the present invention to provide a knotless cord that is capable of exerting sufficient tensile strength of a fibrous body.

In order to achieve the abovementioned object, a knotless cord according to the present invention is a knotless cord, which has a sleeve and a fibrous body inserted into the sleeve, and is constituted by connecting the sleeve and the fibrous body to each other by applying tension in a longitudinal direction of the sleeve and then tightening the sleeve, wherein the knotless cord has locking portions for preventing the fibrous body from slipping out of the sleeve, and wherein the number of sections where the locking portions are provided is at least two.

In the knotless cord according to the present invention, the locking portions for preventing the fibrous body from slipping out of the sleeve are provided in at least two locations. Accordingly, even when relatively large tension is applied, in the entire locking portions the fibrous body and the sleeve are connected to each other by a locking force that is sufficient to prevent the fibrous body from slipping out of the sleeve, and at the same time the locking force is suppressed at each locking portion. In this manner, if the locking force of each locking portion is suppressed, the fibrous body slightly slides between the fibrous body and the sleeve when the tension is applied, whereby the fibrous body can be stretched easily, thus stress generated by application of the tension is absorbed easily as the stretching of the fibrous body. Specifically, the stress generated when the tension is applied is dispersed in the entire fibrous body, whereby stress concentration occurring in each locking portion can be alleviated. Therefore, according to the knotless cord of the present invention, stress concentration occurring in each locking portion can be alleviated while preventing the fibrous body from slipping out of the sleeve, and as a result, sufficient tensile strength of the fibrous body can be exerted.

Moreover, it is preferred that any one of the locking portions be provided at an end portion of the sleeve on a side to which the fibrous body is inserted. Here, in the knotless cord, in a state in which the fibrous body is not connected to the end portion of the sleeve from which the fibrous body is inserted (so-called “opening”), tightening of the sleeve along the longitudinal direction thereof (tightening that is performed by applying tension to the longitudinal direction of the sleeve) is loosened easily in a chain reaction. Therefore, by providing the locking portion at the end portion of the sleeve from which the fibrous body is inserted, the end portion can be securely tightened to prevent the opening, whereby the sleeve and the fibrous body can be connected securely.

At this moment, it is preferred that each of the locking portions be obtained by winding a thread body around the sleeve. In this case, even when the opening supposedly occurs due to a flaw in the thread body, it is possible to prevent the opening from occurring at once.

Specific examples of the fibrous body include a monofilament. The knotless cord of the present invention is suitably used as a trace line.

Moreover, tensile strength of the knotless cord is preferably greater than or equal to knot strength of the fibrous body, and the tensile strength of the knotless cord is preferably at least 60% of tensile strength of the fibrous body. Note that the tensile strength and the knot strength are values measured according to the provisions of JIS L 1013 “Testing methods for man-made filament yarn.”

Moreover, the knotless cord according to the present invention is a knotless cord, which has a sleeve and a fibrous body inserted into the sleeve, and is constituted by connecting the sleeve and the fibrous body to each other by applying tension in a longitudinal direction of the sleeve and then tightening the sleeve, wherein the knotless cord has a locking portion for preventing the fibrous body from slipping out of the sleeve, and wherein the locking portion is provided in plurality so that a locking force of each of the locking portions is suppressed and so that when tension is applied, at least slippage is caused between the sleeve and the fibrous body to facilitate the fibrous body to stretch, whereby stress generated in the fibrous body is dispersed.

As described above, in the knotless cord according to the present invention, by providing the locking portion in plurality, the locking force of each locking portion is suppressed, and, when tension is applied, at least slippage is caused between the sleeve and the fibrous body so as to facilitate the fibrous body to stretch, whereby stress generated in the fibrous body is dispersed. Consequently, the stress concentration occurring in each locking portion can be alleviated while preventing the fibrous body from slipping out of the sleeve, and as a result, sufficient tensile strength of the fibrous body can be exerted.

### BRIEF DESCRIPTION OF THE DRAWINGS

FIG. 1 is a front view showing a knotless cord according to a first embodiment of the present invention;

FIG. 2 is a cross-sectional view of the knotless cord of FIG. 1;

FIG. 3 is a cross-sectional view showing a knotless cord according to a second embodiment of the present invention; and

FIG. 4 shows tables showing results of a tension break strength measurement test for Examples and comparative examples.

### DESCRIPTION OF THE PREFERRED EMBODIMENTS

Preferred embodiments of the present invention will be described hereinafter in detail with reference to the attached drawings. Note that the same elements appearing in the descriptions of the drawings are applied with the same reference numerals, and therefore, overlapping explanations are omitted.

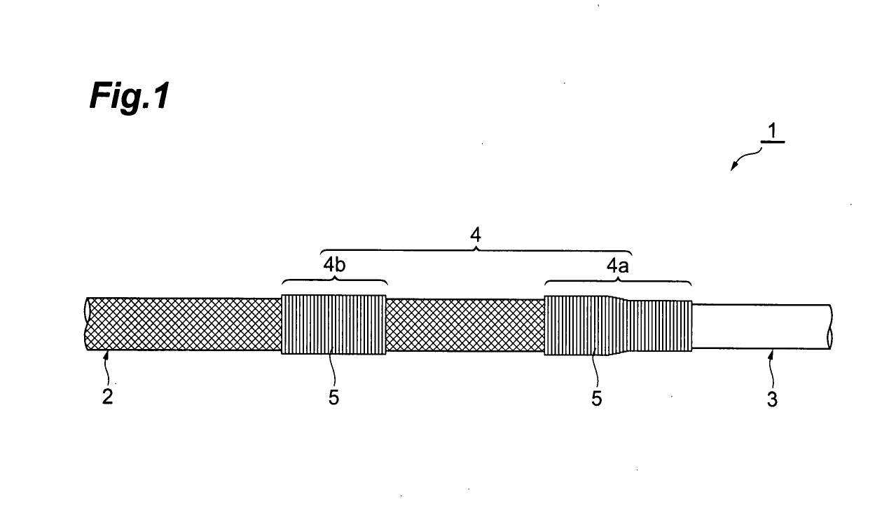

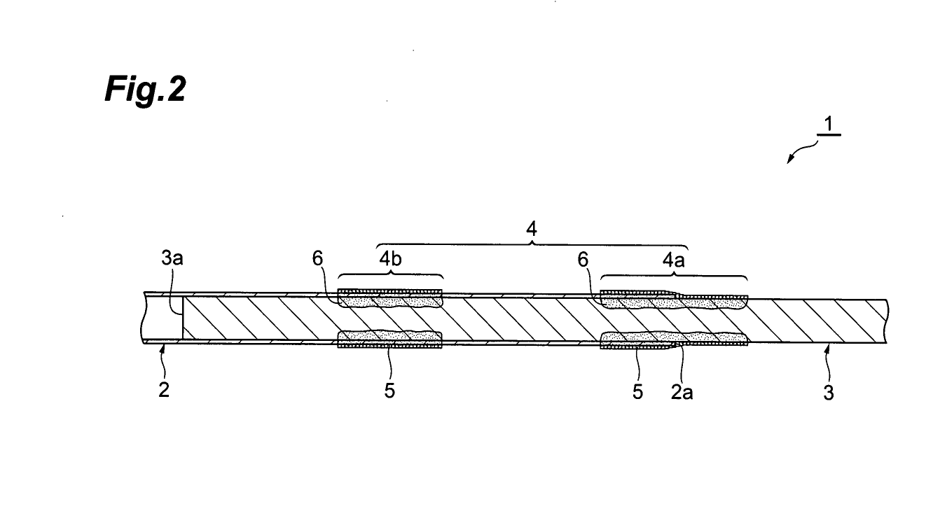

FIG. 1 is a front view showing a knotless cord according to a first embodiment of the present invention, and FIG. 2 is a cross-sectional view of the knotless cord of FIG. 1. The knotless cord here is the one that connects a sleeve and a fibrous body to each other without forming a knot therebetween. A knotless cord 1 of the present embodiment is used as a trace line for fishing and has a sleeve 2 and a fibrous body 3.

The sleeve 2 is a braid formed into a hollow shape and is formed from, for example, a natural fiber such as cotton or wool, a synthetic fiber such as polyester, polyethylene, aliphatic polyamide, aromatic polyamide, poly-p-phenylenebenzobis oxazole (PBO), or liquid crystal polymer (e.g., aromatic polyester), or a combination thereof. Note that the sleeve 2 has tensile strength that is stronger than that of the fibrous body 3.

The fibrous body 3 here is a monofilament 3. This monofilament 3 is a thread formed from a single filament which is formed from, for example, aliphatic polyamide, aromatic polyamide, fluorocarbon, polyester, polyethylene, or the like. In the monofilament 3 a leading end 3a thereof (see FIG. 2) is inserted from an end 2a of the sleeve 2 (see FIG. 2) into the sleeve 2. Then, in this inserted state, tension is applied to the longitudinal direction of the sleeve 2 to tighten the sleeve 2, whereby the sleeve 2 and the monofilament 3 are connected to each other.

Here, the knotless cord 1 is provided with a locking portion 4. This locking portion 4 is to prevent the monofilament 3 from slipping out of the sleeve 2, and is configured from a first locking portion 4a provided on the end 2a side of the sleeve 2, and a second locking portion 4b provided at a position that is separated from the end 2a of the sleeve 2 toward the other end by a predetermined distance.

The first locking portion 4a is formed by winding a thread body 5 therearound by means of, for example, a thread winder such as to cover the end 2a of the sleeve 2, which is a boundary between the sleeve 2 and monofilament 3, and the vicinity thereof. Specifically, the first locking portion 4a is formed by winding the thread body 5 around a region that extends longitudinally from the end 2a of the sleeve 2 by 0.75 cm. In the first locking portion 4a, for example, cyanoacrylate instant adhesive 6 (see FIG. 2) is applied, whereby connection between the sleeve 2 and the monofilament 3 at this position is reinforced.

The second locking portion 4b is provided at a position closer to the sleeve 2 than the first locking portion 4a, and is formed by winding the thread body 5 therearound by means of, for example, a thread winder. Specifically, the second locking portion 4b is formed by winding the thread body 5 around a region that extends longitudinally by, for example, 0.5 cm, from the position that is separated from the end 2a of the sleeve 2 toward the other end at a predetermined distance (approximately 5 cm in this case). Then, in the second locking portion 4b, as with the first locking portion 4a, for example, the cyanoacrylate adhesive 6 is applied, whereby connection between the sleeve 2 and the monofilament 3 at this position is reinforced.

Note that in the present embodiment, tensile strength of the knotless cord 1 is 60% or more of tensile strength of the monofilament 3, but it is preferably 70% or more, and more preferably 75% or more. Moreover, the tensile strength of the knotless cord 1 is stronger than knot strength of the monofilament 3 (i.e., 100% or more of the knot strength of the monofilament 3), but it is preferably 105% or more, and more preferably 110% or more.

Incidentally, the tensile strength and the knot strength described above and hereinafter are values measured according to the provisions of JIS L 1013 “Testing methods for man-made filament yarn.” Specifically, the tensile strength indicates the strength against tension, i.e., the amount of pulling load that ruptures the monofilament. The knot strength indicates tensile strength of the fibrous body connected by a half-knot, i.e., the amount of pulling load that ruptures the connected fibrous body.

In the knotless cord 1 configured as described above, when tension of pulling is applied, connection between the sleeve 2 and the monofilament 3 is maintained by the tightening force of the sleeve 2 and the locking force of the locking portion 4. Note that the locking force indicates a force that prevents the monofilament 3 from slipping out of the sleeve 2. In the locking portion 4, the locking force means a tightening force generated when winding the thread body 5, and an adhesive force generated when the instant adhesive 6 is applied.

When the tension of pulling is applied, the sections provided with the locking force 4 are the two sections: the first locking portion 4a and the second locking portion 4b (the section provided with the locking portion 4 is divided into these two sections of the first locking portion 4a and the second locking portion 4b), as described above. For this reason, the locking portion 4 as a whole uses sufficient locking force to connect the monofilament 3 and the sleeve 2 to each other such as to prevent the monofilament 3 from slipping out of the sleeve 2, while suppressing the locking force of each of the locking portions 4a, 4b. In this manner, if the locking force of each of the locking portions 4a, 4b is suppressed, the monofilament 3 can slightly slides between the monofilament 3 and the sleeve 2 and easily stretches when tension is applied, thus stress generated accordingly is easily absorbed as the stretching of the monofilament 3. Specifically, stress that is generated when tension is applied is dispersed throughout the entire monofilament 3, whereby stress concentration occurring in each of the locking portions 4a, 4b is alleviated (stress dispersion effect is obtained). Therefore, according to the present embodiment, sufficient tensile strength of the monofilament 3 can be exerted.

Moreover, as described above, since the locking portion 4a is provided at an end portion on the end 2a side of the sleeve 2, this end portion can be tightened securely to prevent the occurrence of a situation where the monofilament 3 is not connected to the end portion on the side of the sleeve 2 from which the monofilament 3 is inserted (end 2a side) (so-called “opening”). Accordingly, a general problem that normally occurs in the knotless cord, i.e., the problem that tightening of the sleeve 2 is easily loosened in a chain reaction in the longitudinal direction in the state of opening, is vanished, whereby the sleeve 2 and the monofilament 3 can be connected to each other securely.

Since the locking portion 4a is configured by winding the thread body 5 around the sleeve 2, the opening can be prevented from occurring at once even when the thread body 5 is loosened or damaged and thereby the opening supposedly occurs.

Moreover, as described above, since the sleeve 2 has tensile strength that is stronger than that of the monofilament 3, when tension is applied to the knotless cord 1 the sleeve 2 is prevented from rupturing before the monofilament 3, thus sufficient tensile strength of the monofilament 3 can be exerted.

Here, when connecting fibrous fibers to each other by forming a knot therebetween, generally the strength obtained at the knot is weaker than the strength of the straight lines when pulling them. However, according to the present embodiment, since the tensile strength of the knotless cord 1 is greater than or equal to the knot strength of the monofilament 3, as described above, the sleeve 2 and the monofilament 3 can be suitably connected to each other, compared to when connecting them by forming a knot therebetween. In addition, in the present embodiment, since the tensile strength of the knotless cord 1 is 60% or more of the tensile strength of the monofilament 3 as described above, sufficient tensile strength of the monofilament 3 can be exerted. These effects become notable as the diameter of the monofilament 3 increases, and become particularly notable when the knotless cord is used as a trace line, such as a fishing line used for fishing tuna or large-size fish.

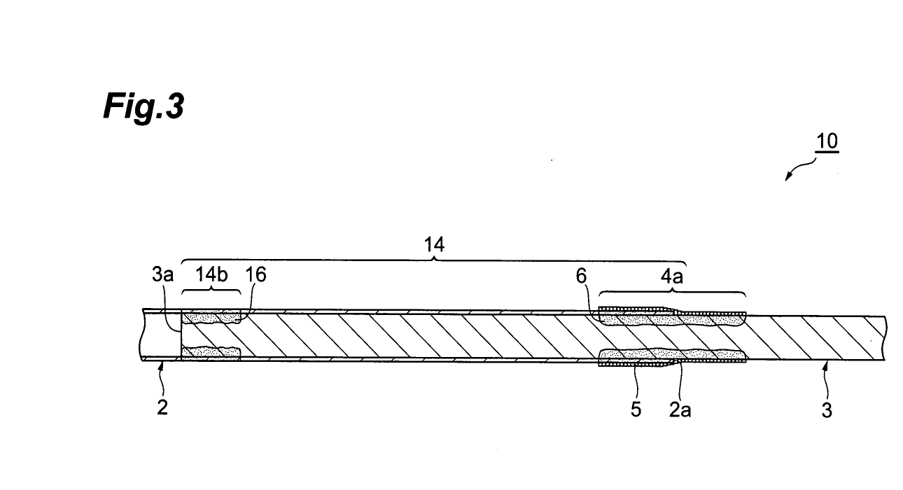

Next, a knotless cord 10 according to a second embodiment of the present invention will be described. FIG. 3 is a cross-sectional view showing the knotless cord according to the second embodiment of the present invention. The difference between the knotless cord 10 of the second embodiment and the knotless cord 1 of the first embodiment is that the knotless cord 10 has a locking portion 14 having a first locking portion 4a and a second locking portion 14b shown in FIG. 3 in place of the locking portion 4 having the first locking portion 4a and the second locking portion 4b shown in FIG. 1 and FIG. 2.

The second locking portion 14b is provided by applying, for example, instant adhesive 16 to a section corresponding to a leading end 3a of the monofilament 3 inserted into the sleeve 2, that is, a position that is separated from the end 2a of the sleeve 2 toward the other end side by the distance in which the monofilament 3 is inserted, and a position in the vicinity of the abovementioned position. Note that the locking force of the second locking portion 14b indicates an adhesive force between the sleeve 2 and the monofilament 3 that is obtained by applying the instant adhesive 16.

In the present embodiment as well, the same effect as the one described above is achieved: the effect of alleviating stress concentration occurring in the locking portion 14 while preventing the monofilament 3 from slipping out of the sleeve 2, to thereby exert sufficient tensile strength of the monofilament 3. Moreover, as described above, since the second locking portion 14b is formed in the section corresponding to the leading end 3a of the monofilament 3 inserted into the sleeve 2, the locking force can be exerted suitably, and the monofilament 3 and the sleeve 2 can be connected to each other securely.

The above has described the preferred embodiments of the present invention, but the present invention is not limited to the embodiments described above. For example, the locking portion is provided in two sections in the above-described embodiments, but it may be provided in three or more sections.

Moreover, the locking portion may be configured by winding a thread body, by applying an adhesive, by performing both of them, or by performing other things.

Examples and comparative examples will be described hereinafter.

### Example 1

First, a PVDF (polyvinylidene-fluoride) monofilament was inserted into an ultrahigh molecular weight polyethylene sleeve, and tension was applied to the longitudinal direction of the sleeve to tighten the sleeve, whereby the sleeve and monofilament were connected to each other. The size of the sleeve was 6, and the size of the monofilament was 14.

Then, the first locking portion was formed on the insertion port of the sleeve (one end side of the sleeve from which the monofilament is inserted), and the second locking portion was formed in a position on the sleeve that is separated from the insertion port at approximately 5 cm internally in the longitudinal direction. After a thread body was wound around the sleeve by means of a Bobbin Knoter™ (produced by YGK YOZ-AMI Co., Ltd.), the cyanoacrylate instant adhesive was applied thereto to form the first and second locking portions. In this manner, a target knotless cord was obtained.

### Example 2

The same processing as Example 1 was performed excepted that the size of the monofilament was changed to 16.

### Example 3

The same processing as Example 1 was performed except that the size of the monofilament and the size of the sleeve were changed to 20 and 8 respectively.

### Example 4

The same processing as Example 1 was performed except that the size of the monofilament and the size of the sleeve were changed to 30 and 10 respectively.

### Example 5

The same processing as Example 1 was performed except that the size of the monofilament and the size of the sleeve were changed to 40 and 15 respectively.

### Example 6

The same processing as Example 1 was performed except that the size of the monofilament and the size of the sleeve were changed to 50 and 15 respectively.

### Example 7

The same processing as Example 1 was performed except that the thread body was not wound around the second locking portion and that the size of the monofilament and the size of the sleeve were changed to 30 and 10 respectively.

### Comparative Example 1

After the thread body was wound tightly around the first locking portion so that the sleeve and the monofilament do not move relatively with each other, the first locking portion was subjected to welding processing, and the same processing as Example 1 was performed, except that the second locking portion was not formed and that the size of the monofilament and the size of the sleeve were changed to 14 and 6 respectively.

### Comparative Example 2

The same processing as Comparative Example 1 was performed except that the size of the monofilament was changed to 16.

### Comparative Example 3

The same processing as Comparative Example 1 was performed except that the size of the monofilament and the size of the sleeve were changed to 20 and 8 respectively.

### Comparative Example 4

The same processing as Comparative Example 1 was performed except that the size of the monofilament and the size of the sleeve were changed to 40 and 15 respectively.

### Comparative Example 5

The same processing as Comparative Example 1 was performed except that the size of the monofilament and the size of the sleeve were changed to 80 and 25 respectively.

### Tension Break Strength Measurement Test

The tensile strength of the knotless cord was measured by performing a tension break strength measurement test using Examples 1 through 7 and Comparative Examples 1 through 5. Specifically, in the knotless cord the end portion on the sleeve side was fixed, and the end portion on the monofilament side was connected to a load cell and then applied with tension. Note that in this tension break strength measurement test a Strograph RII™ type tension tester (produced by KK. Toyo Seiki Seisaku-sho) was used to measure the tensile strength of the knotless cord according to the provisions of JIS L 1013 “Testing methods for man-made filament yarn.”

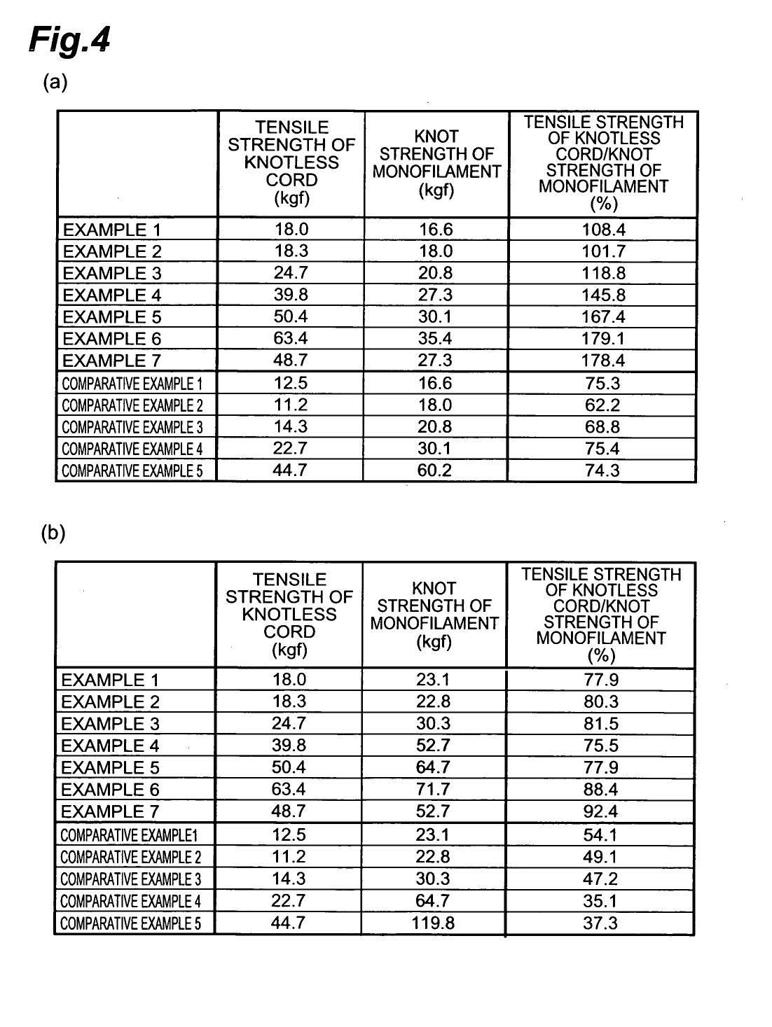

As a result of this test, [tensile strength of knotless cord/knot strength of monofilament] was lower than 100% (the tensile strength of the knotless cord was lower than the knot strength of the monofilament) in Comparative Examples 1 through 5, while [tensile strength of knotless cord/knot strength of monofilament] was greater than or equal to 100% (the tensile strength of the knotless cord was greater than or equal to the knot strength of the monofilament) in Examples 1 through 7, as shown in (a) of FIG. 4. Therefore, it could be confirmed that in the knotless cord of the Examples, the tensile strength thereof was greater than or equal to the knot strength of the fibrous body. Also, the effect of obtaining better connection between the sleeve and the monofilament compared to when connecting them by forming a knot therebetween, and the effect of obtaining better connection between the sleeve and the monofilament compared to when connecting them by providing the locking portion in one section could be confirmed.

Moreover, [tensile strength of knotless cord/tensile strength of monofilament] was lower than 54.1% in Comparative Examples 1 through 5, while [tensile strength of knotless cord/tensile strength of monofilament] was greater than or equal to 75.5% in Examples 1 through 7, as shown in (b) of FIG. 4. Specifically, in Examples 1 through 7 [tensile strength of knotless cord/tensile strength of monofilament] is at least 75.5% and at most 92.4% (approximately 90% of the tensile strength of the monofilament). Therefore, in the knotless cord of these Examples, the tensile strength thereof is at least 60% or more of the tensile strength of the monofilament even when considering variation in the products, thus the abovementioned effects of exerting sufficient tensile strength of the monofilament could be confirmed. In addition, the larger the diameter of the monofilament, the greater the [tensile strength of knotless cord/tensile strength of monofilament], thus it could be confirmed that the abovementioned effect, that is, the effect of exerting sufficient tensile strength of the monofilament becomes notable as the large diameter of the monofilament increases.

According to the present invention, a knotless cord that is capable of exerting sufficient tensile strength of a fibrous body can be provided.

What is claimed is:

1. A knotless cord, which comprises a sleeve and a fibrous body inserted into the sleeve, and is constituted by connecting the sleeve and the fibrous body to each other by applying tension in a longitudinal direction of the sleeve and then tightening the sleeve, wherein
the knotless cord has locking portions for preventing the fibrous body from slipping out of the sleeve, and
the number of sections where the locking portions are provided is at least two.

2. The knotless cord according to claim 1, wherein any one of the locking portions is provided at an end portion of the sleeve on a side to which the fibrous body is inserted.

3. The knotless cord according to claim 2, wherein each of the locking portions are obtained by winding a thread body around the sleeve.

4. The knotless cord according to claim 1, wherein the fibrous body is a monofilament.

5. The knotless cord according to claim 1, which is used as a trace line.

6. The knotless cord according to claim 1, wherein tensile strength of the knotless cord is greater than or equal to knot strength of the fibrous body.

7. The knotless cord according to claim 1, wherein tensile strength of the knotless cord is at least 60% of tensile strength of the fibrous body.

8. A knotless cord, which comprises a sleeve and a fibrous body inserted into the sleeve, and is constituted by connecting the sleeve and the fibrous body to each other by applying tension in a longitudinal direction of the sleeve and then tightening the sleeve, wherein
the knotless cord has a locking portion for preventing the fibrous body from slipping out of the sleeve, and
the locking portion is provided in plurality so that a locking force of each of the locking portions is suppressed and so that when tension is applied, at least slippage is caused between the sleeve and the fibrous body to facilitate the fibrous body to stretch, whereby stress generated in the fibrous body is dispersed.
